(19) United States
(12) Patent Application Publication
(10) Pub. No.: US 2008/0094950 A1
(43) Pub. Date: Apr. 24, 2008

(54) OPTICAL PICKUP APPARATUS, METHOD OF PRODUCING THE SAME, AND OPTICAL INFORMATION RECORDER-REPRODUCER INCLUDING THE SAME

(75) Inventors: Masahiro NAKAMURA, Higashihiroshima-shi (JP); Akiho Yoshizawa, Higashihiroshima-shi (JP); Taizou Yokota, Higashihiroshima-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 11/852,892

(22) Filed: Sep. 10, 2007

(30) Foreign Application Priority Data
Oct. 24, 2006 (JP) 2006-289170

(51) Int. Cl. G11B 7/00

(52) U.S. Cl. 369/44.23

(57) ABSTRACT

In an optical pickup apparatus of the present invention, an integrated optical unit including at least a light emitting element, a light receiving element, and an optical element is installed on a housing. The housing includes arrangement sections on which the respective elements of those at least the light emitting element, the light receiving element, and the optical element are to be rigidly mounted so that the respective elements are integral with the housing via the arrangement sections. In other words, the integrated optical unit is installed on the housing by use of a discrete method so that positional adjustment of respective optical components is simplified. The optical components are adjusted highly precisely in a simplified manner so that optical pickup apparatuses that are small, light, and high-quality are provided.

This Nonprovisional application claims priority under 35 U.S.C. § 119(a) on Patent Application No. 289170/2006 filed in Japan on Oct. 24, 2006, the entire contents of which are hereby incorporated by reference.

### FIELD OF THE INVENTION

The present invention relates to an optical pickup apparatus, a method of producing the optical pickup apparatus, and an optical information recorder-reproducer including the optical pickup apparatus Particularly, the present invention relates to an optical pickup apparatus, a method of producing the optical pickup apparatus, and an optical information recorder-reproducer including the optical pickup apparatus, in which optical pickup apparatus a light source, diffracting means, light guiding means, and a light receiving element are rigidly mounted directly on a housing so that adjustment of positions of those optical components is simplified.

### BACKGROUND OF THE INVENTION

Over the recent years, there have been demands for optical recording media having an information recording capacity of higher density and larger capacity to record high-quality images and moving images. To use an optical recording medium in a mobile use such as laptops, a smaller and lighter optical pickup apparatus for reproducing and/or recording information of the optical recording media is necessary.

In a conventional optical pickup apparatus, optical components such as a semiconductor laser and a diffraction grating are provided on a housing, as described in for example Publication 1 [Japanese Unexamined Patent Publication No. 119653/1994 (Tokukaihei 6-119653 (publication date: Apr. 28, 1994)). However, with the layout of the optical components as illustrated in Publication 1, the photo detector is provided distantly from the light source and the diffraction grating. This makes it difficult to reduce the optical pickup apparatus in size and weight. One of the reasons why reduction in size and weight is difficult, which is not clearly indicated in Publication 1, is that, because an ancillary component such as a holder is utilized to mount each of the optical components on the housing, spaces for the ancillary components to be mounted are provided. The ancillary components are employed to facilitate positional adjustment of the optical components. The larger the component is, the easier the adjustment is. Therefore, an ancillary component is provided to each of the optical components. This, however, makes it difficult to reduce the size and the weight.

In view of the foregoing, conventionally, an integrated optical unit is produced by integrating optical components such as a light source and a light receiving element into a unit, and then the integrated optical unit is installed into the optical pickup apparatus, whereby the optical pickup apparatuses is reduced in size and weight. Further, along with this size and weight reduction, the sizes of the respective optical components are also reduced. This raises a demand for a technique by which positions of the optical components are easily adjusted even if the sizes of the optical components are small. To meet the demand, there have been proposed techniques by which a size and weight of an optical pickup apparatus is reduced, and at the same time, adjustment is facilitated to reduce deviations in adjustment and assembly (for example in Publication 2 [Japanese Unexamined Patent Publication No. 79231/1990 (Tokukaihei 2-79231) (publication date: Mar. 19, 1990)], Publication 3 [Japanese Unexamined Patent Publication No. 65935/2006 (Tokukai 2006-65935) (publication date: Mar. 9, 2006)], and Publication 4 [Japanese Unexamined Patent Publication No. 225583/1993 (Tokukaihei 5-225583) (publication date: Sep. 3, 1993)]).

The following describes the structure of the optical pickup apparatus disclosed in Publication 2, with reference to FIG. 5. FIG. 5 is a figure schematically showing the structure of the optical pickup apparatus disclosed in Publication 2. As shown in FIG. 5, the light beam emitted from the semiconductor laser 101 is divided into a main beam (0th order light) and two sub beams (±first order light) by the diffraction grating 102 for three beams, and then reaches the hologram element 103. Only light (0th order diffracted light) having passed through the hologram element 103 is gathered onto the optical disk 105 via the object lens 104. Light having been reflected from the optical disk 105, that is to say, return light is guided, together with the main beam and the two sub beams, to the hologram element 103 via, again, the object lens 104. Then, only light diffracted by the hologram element 103 (first order diffracted light) enters the photodiode 106 so that various signals are generated.

The semiconductor laser 101, the diffraction grating 102, the hologram element 103, and the photodiode 106 are combined into a unit and integrated inside of a hologram unit (integrated optical unit). This, according to the publication, simplifies the structure of the optical-system base unit, allows reduction in size and integration, reduces the number of components, and facilitates adjustment of phases of spots for detecting tracking errors.

The following describes the structure of the optical pickup apparatus disclosed in Publication 3, with reference to FIGS. 6(a) and 6(b). FIGS. 6(a) and 6(b) are figures each showing a schematic structure of the integrated optical unit used in the optical pickup apparatus disclosed in Publication 3. FIG. 6(a) is a sectional view of the integrated optical unit taken along the optical-axis direction (direction Z) and viewed from direction Y. FIG. 6(b) is a plan view of the integrated optical unit, excluding the polarization grating 206 and the polarized light beam splitter 202 shown in FIG. 6(a), viewed from the optical-axis direction (direction Z). As shown in FIGS. 6(a) and 6(b), the integrated optical unit disclosed in Publication 3 includes a semiconductor laser 201, a polarized light beam splitter 202 having a polarized light beam splitter surface 207, a light receiving element 203, and a polarization grating 206 including a first hologram element 204, which diffracts return light, and a second hologram element 205, which diffracts a light beam. A light beam having passed through the polarized light beam splitter surface 207 enters the polarization grating 206. The optical path of return light having been diffracted by the polarization grating 206 is changed by the polarized light beam splitter surface 207, and then the return light is received by the light receiving element 203.

The semiconductor laser 201, the polarized light beam splitter 202, the light receiving element 203, and the polarization grating 206 are integrated into a unit to form an integrated optical unit 208 so that the optical pickup apparatus is reduced in size and weight. The position of the semiconductor laser 201 is adjustable with respect to the light receiving element 203 and the polarized light beam splitter 202. The first hologram element 204 and the second hologram element 205 are produced integrally. Thus, according to the publication, assembly and adjustment of the integrated optical unit 208 are facilitated.

Publication 4 discloses an optical pickup apparatus in which the light source unit including the light emitting element, the light receiving element, and the diffracting element that are integrated is assembled first, and then the light source unit is mounted on the optical head. In the optical pickup apparatus of Publication 4, first, the position of the object lens is adjusted, on an optical-head alternative component including an object lens, at the time of assembly of the light source unit in such a manner that the total signals calculated on the basis of the amount of light received by the light receiving element becomes a maximum. At the same time, focus error signals and tracking error signals are detected to adjust the position of the diffracting element. Thereafter, the light source unit is mounted on the optical head, the optical axis and the light intensity distribution are adjusted, and then the position of the light source unit is fixed.

Further, Publication 5 [Japanese Unexamined Patent Publication No. 273336/1990 (Tokukaihei 2-273336) (publication date: Nov. 7, 1990)] discloses the following technique. In an optical pickup apparatus that is to be installed in compact disk players and the like, a section of the diffracting element, on which section the diffraction grating is to be provided, is arranged in such a manner that first order diffracted light having been diffracted by the diffracting element does not enter the lens system, whereby false signals are reduced significantly.

However, with the technique in which the integrated optical unit is produced and then mounted on the optical pickup apparatus as discussed in Publications 2 to 4 for example, positional adjustments and the like during the assembly of the integrated optical unit are complicated because each of the components is small. Further, errors such as deviations in adjustment easily occur during the adjustments owing to interference between the components. Further, the optical components constituting the integrated optical unit are adjusted, and then the integrated optical unit is mounted on the optical pickup apparatus. Thereafter, the optical integrated unit is adjusted again. Accordingly, adjustment needs to be carried out twice, which causes inefficiency of the process.

The following discusses the above problems, with reference to FIG. 7. FIG. 7 shows a flowchart of an assembly and adjustment process according to the technique in which an integrated optical unit is produced, and then the integrated optical unit is mounted on an optical pickup apparatus.

First, optical components such as a light source, a light receiving element, and a diffracting element are mounted on a package component of the integrated optical unit. At this time, the light source, the light receiving element, and the diffracting element are provisionally fastened so that the positions and the like of the light source, the light receiving element, and the diffracting element are adjustable.

Thereafter, the optical axis and the light intensity distribution of the light source are adjusted, and then the positions of the light receiving element and the diffracting element are adjusted to optimize an MPP (main push pull) balance. Then, the positions of the light receiving element and the diffracting element are fixed. Finally, the assembly and adjustment process of the integrated optical unit is completed.

In the optical pickup apparatus, the collimator lens, the quarter-wave plate, the rising mirror, and the like are fixed to the housing, which supports the integrated optical unit and other optical components.

Then, the integrated optical unit is provisionally fastened to the housing in such a manner that the position of the integrated optical unit is adjustable.

At this time, the MPP balance is adjusted so as to be optimized, and then the components are fixed, as described above, in the assembly and adjustment process of the integrated optical unit. However, due to assembly errors of the collimator or the like already mounted on the housing, there arises deviation in the MPP balance when an actuator, in which the object lens is positioned at a reference position (the reference position will simply be referred to as “reference position” hereinafter) calculated in advance as an optimum position for the object lens, is mounted on the housing.

Thus, in order to adjust the MPP balance again, the object lens in the actuator needs to be displaced from the reference position, and the optical axes and the positions of the optical components in the integrated optical unit need to be adjusted again. In other words, the optical axis of the semiconductor laser needs to be adjusted again after the integrated optical unit is provisionally fastened. Furthermore, the positions of the diffracting element and the light receiving element need to be adjusted again as a result of the adjustment of the optical axis, and owing to assembly error of optical components constituting the integrated optical unit and optical components constituting the optical pickup apparatus.

Thereafter, the object lens is moved upward and downward repeatedly in the optical-axis direction (direction Z) to adjust the actuator. In other words, the posture of the actuator is adjusted by adjusting a tilt with respect to the optical axis. The position of the actuator is also adjusted in directions X and Y with respect to direction Z. By this adjustment of the actuator, the position of the object lens is adjusted while signals from the diffracting element or the light receiving section of the light receiving element are detected so that the MPP balance is optimized. After this adjustment is finished, the actuator and the integrated optical unit are fixed.

This inefficiency of carrying out adjustments such as optical-axis adjustment and positional adjustment twice arises because the optical components mounted directly on the housing and the integrated optical unit formed as a separate component are adjusted as if the optical components and the integrated optical unit are one component. For example in the optical pickup apparatus disclosed in Publication 2, the hologram unit and the optical-system base unit are provided as separate components. In the optical pickup apparatus disclosed in Publication 3, the integrated optical unit and the components supporting the object lens and the like are provided as separate components. In the optical head disclosed in Publication 4, the light source unit and the optical-head alternative component are provided as separate components. Thus, inefficiency of carrying out adjustment twice arises. Furthermore, assembly error occurs as a result of assembling the components.

It can be said that adjustment needs to be carried out twice because the optical system only for adjusting the integrated optical unit does not always match the optical system formed by the integrated optical unit and other optical components when the integrated optical unit is mounted on the housing.

In an optical pickup apparatus having an actuator including a plurality of object lenses, such as an optical pickup apparatus having a light source of plural wavelengths, the position of the actuator is adjusted on the basis of one object lens. Therefore, if the position of the object lens is deviated from a reference position, the positions of other object lenses also deviate from the reference position. As a result, assembly error of the integrated optical unit and the optical components that are rigidly mounted directly on the housing need to be corrected, on the basis of the optical system of the object lenses deviated from the reference position.

Thus, the positional adjustment becomes further complicated, so that it becomes difficult to prevent deterioration in characteristics of the optical pickup apparatuses, such as deterioration in quality of spots at the time of recording information with the optical recording medium.

Further, with regard to a package component of the integrated optical unit, normally, a thin metal plate is processed to bend by pressing. This, in many cases, results in irregularities in precision of processing surfaces on which individual optical components such as diffracting elements are to be mounted. Thus, a required precision of adjustment differs among the optical components. Furthermore, the optical components move on the package component. Thus, the adjustment process becomes complicated.

Meanwhile, the optical head disclosed in Publication 1 has a problem that reduction in size and weight is difficult because the ancillary components are provided to the optical components, as described above. Publication 5 is silent on whether or not it is possible to integrate the optical components such as a diffraction grating and a light receiving element. Publication 5 is also silent on how the positions are adjusted. In other words, Publication 5 does not discuss a concrete method for reducing the size of the optical head and therefore does not disclose a technique for producing a small and light optical pickup apparatus with simplified positional adjustment.

### SUMMARY OF THE INVENTION

The present invention is in view of the above problems, and has as an object to provide a small, light, and high quality optical pickup apparatus by adjusting optical axes and positions of optical components highly precisely in a simplified manner.

To solve the above problems, an optical pickup apparatus of the present invention is adapted so that, in the optical pickup apparatus, an integrated optical unit is installed on a housing and includes at least a light emitting element, a light receiving element, and an optical element, the housing including arrangement sections on which respective elements of those at least the light emitting element, the light receiving element, and the optical element are to be rigidly mounted so that the respective elements are integral with the housing via the arrangement sections.

With this structure, the integrated optical unit including at least the light emitting element, the light receiving element, and the optical element is mounted directly on the housing in the optical pickup apparatus. This makes it possible to adjust the positions of the light emitting element, the light receiving element, and the optical element on one housing. Thus, the optical pickup apparatus is produced with simplified adjustment. In other words, it is not necessary to carry out adjustment twice as the way it has been carried out conventionally, that is to say, the respective elements of the integrated optical unit are adjusted when the integrated optical unit is assembled, and then adjusted again after the integrated optical unit is installed on the housing. This makes it possible to produce the optical pickup apparatus through a reduced number of processes. Further, conventionally, there has been a deviation between a reference optical system, which is referred to when the optical components are adjusted in the integrated optical unit, and an optical system at the time when the integrated optical unit is actually installed on the housing. This complicates the adjustments, and deviations easily occur. However, with the above structure, this problem does not occur since all adjustments are carried out on one housing.

Further, to ensure strength, the housing is normally made thick using a die-cast metal of aluminum, zinc, magnesium, or the like, or a molded resin such as PPS resin. This improves evenness in precision of processing the surfaces. Further, the optical components are mounted directly onto the die-cast metal and the molded resin. Thus, it becomes possible to produce the optical pickup apparatuses with simplified adjustment including positional adjustment. Further, the optical components are rigidly mounted directly onto the housing, without requiring a package component of low strength, such as a conventional integrated optical unit. Thus, the optical components do not move during the adjustments so that the positions of the optical components after the adjustment are stabilized.

Further, the light emitting element, the light receiving element, and the optical element are integrated into a unit so that the optical pickup apparatus is reduced in size and weight.

This produces an advantage that a small, light, and high quality optical pickup apparatus is provided.

To solve the above problems, an optical pickup apparatus is adapted so that, in the optical pickup apparatus, an integrated optical unit and object lens adjusting means for adjusting a position of an object lens gathering, to an optical recording medium, a light beam having been emitted from light source means are installed, which integrated optical unit includes at least light source means for emitting a light beam, a light receiving element, light guiding means for guiding, in a direction different from a direction of the light source means, return light which is the light beam having been reflected from the optical recording medium, and diffracting means for diffracting the light beam and the return light, the optical pickup apparatus including a housing having arrangement sections, formed in advance, on which the light source means, the light receiving element, the light guiding means, the diffracting means, and the object lens adjusting means are to be rigidly mounted.

With this structure, the object lens adjusting means and the integrated optical unit including at least the light source means, the light guiding means, the light receiving element, and the diffracting means are installed directly on the housing. This makes it possible to carry out all of the following adjustments on the housing: adjustment of the optical axis of the light beam emitted from the light source; adjustment of the light intensity distribution; adjustment of the posture of the actuator; adjustment of the position of the light receiving element; and adjustment of the position of the diffracting element. Thus, the adjustments are simplified. Specifically, it is not necessary to carry out adjustment twice as the way it has been carried out conventionally, that is to say, adjustment is carried out in the integrated optical unit, and then adjustment is carried out again after the integrated optical unit is installed on the housing. Thus, the number of processes is reduced.

Further, to ensure strength, the housing is normally made thick using a die-cast metal of aluminum, zinc, magnesium, or the like, or a molded resin such as PPS resin. This improves evenness in precision of processing the surfaces. Further, the optical components, such as the light guiding means, are mounted directly onto the die-cast metal and the molded resin. Further, the optical components are rigidly mounted directly onto the housing, without requiring a package component of low strength, such as a conventional integrated optical unit. Thus, the optical components do not move during the adjustments so that the positions of the optical components after the adjustment are stabilized. Specifically, it is not necessary to carry out adjustment twice as the way it has been carried out conventionally, that is to say, adjustment is carried out in the integrated optical unit, and then adjustment is carried out again after the integrated optical unit is installed on the housing. Thus, the number of processes is reduced. Further, conventionally, there has been a deviation between a reference optical system, which is referred to when the optical components are adjusted in the integrated optical unit, and an optical system at the time when the integrated optical unit is actually installed on the housing. This complicates the adjustments, and deviations easily occur. However, with the above structure, this problem does not occur since all adjustments are carried out on one housing.

Further, the light emitting element, the light receiving element, and the optical element are integrated into a unit so that the optical pickup apparatus is reduced in size and weight.

This produces an advantage that a small, light, and high quality optical pickup apparatus is provided.

To solve the above problems, a method of producing an optical pickup apparatus in accordance with the present invention is adapted so that the method of producing an optical pickup apparatus in which an integrated optical unit is installed on a housing and includes at least a light emitting element, a light receiving element, and an optical element, the housing including arrangement sections on which respective elements of those at least the light emitting element, the light receiving element, and the optical element are to be rigidly mounted, includes: preparing for forming the integrated optical unit integral with the housing by rigidly mounting the respective elements on the arrangement sections of the housing; and making optical adjustment to the respective elements being rigidly mounted.

With this arrangement, in the adjustment, the integrated optical unit including at least the light emitting element, the light receiving element, and the optical element is installed directly on the housing. This makes it possible to adjust the positions of all of the light emitting element, the light receiving element, and the optical element on one housing. Thus, the optical pickup apparatus is produced with simplified adjustment. In other words, it is not necessary to carry out adjustment twice as the way it has been carried out conventionally, that is to say, adjustment is carried out in the integrated optical unit, and then adjustment is carried out again after the integrated optical unit is installed on the housing. This makes it possible to produce the optical pickup apparatus through a reduced number of processes.

Further, to ensure strength, the housing is normally made thick using a die-cast metal of aluminum, zinc, magnesium, or the like, or a molded resin such as PPS resin. This improves evenness in precision of processing the surfaces. Further, the optical components are mounted directly onto the die-cast metal and the molded resin. Thus, it becomes possible to produce the optical pickup apparatuses with simplified adjustment including positional adjustment. Further, the optical components are rigidly mounted directly onto the housing, without requiring a package component of low strength, such as a conventional integrated optical unit. Thus, the optical components do not move during the adjustments so that the positions of the optical components after the adjustment are stabilized.

Further, the light emitting element, the light receiving element, and the optical element are integrated into a unit so that the size and the weight of the optical pickup apparatus are reduced.

This produces an advantage that a small, light, and high quality optical pickup apparatus is provided.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a plan view showing a schematic structure of an optical pickup apparatus in accordance with an embodiment of the present invention.

FIG. 2 is a plan view showing a schematic structure in the vicinity of a semiconductor laser employed in the optical pickup apparatus shown in FIG. 1.

FIG. 3 is a flowchart showing the processes of a method of producing the optical pickup apparatus in accordance with an embodiment of the present invention.

FIG. 4 is a figure schematically showing how an optical pickup apparatus is produced by a method of producing an optical pickup apparatus in accordance with another embodiment of the present invention.

FIG. 5 is a figure showing a schematic structure of a conventional optical pickup apparatus.

FIG. 6(a) is a figure showing a schematic structure of an integrated optical unit used in another conventional optical pickup apparatus.

FIG. 6(b) is a figure showing a schematic structure of the integrated optical unit shown in FIG. 6(a), viewed from a different direction.

FIG. 7 is a flowchart showing processes of assembling and adjusting the optical pickup apparatus shown in FIGS. 6(a) and 6(b).

FIG. 8 is a figure schematically showing how an optical pickup apparatus is produced by a method of producing an optical pickup apparatus in accordance with a comparative example.

### DESCRIPTION OF THE EMBODIMENTS

### First Embodiment

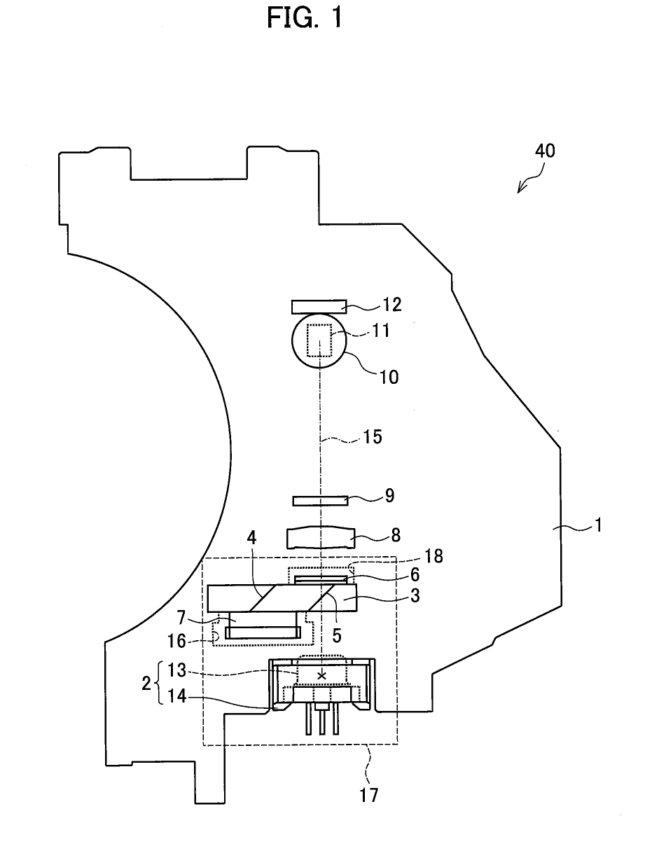

The following describes an embodiment of the present invention, with reference to FIGS. 1 to 3.

First, a structure of an optical pickup apparatus 40 of the present invention is described, with reference to FIG. 1.

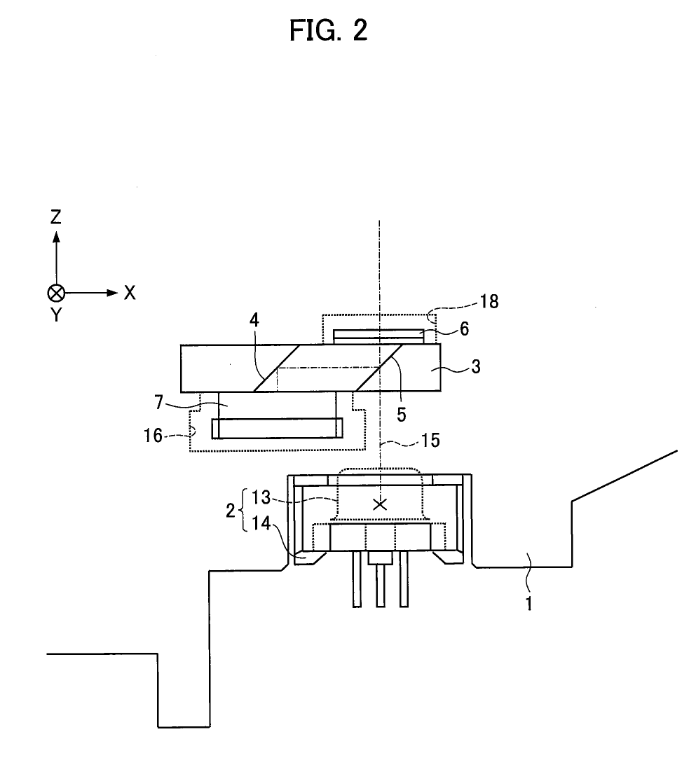

FIG. 1 is a plan view showing a schematic structure of the optical pickup apparatus 40 of an embodiment of the present invention. FIG. 2 is a plan view showing a schematic structure in the vicinity of a light emitting element 2.

As shown in FIGS. 1 and 2, the optical pickup apparatus 40 of the present embodiment includes, in a housing 1, a collimator lens 8, a quarter-wave plate 9, an object lens 10 (optical element), a rising mirror 11, an actuator 12 (object lens adjusting means), and an integrated optical unit 17.

The integrated optical unit 17 including a light emitting element 2, a polarized light beam splitter 3 (light guiding means (optical element)), a diffracting element 6 (diffracting means (optical element)), and a light receiving element 7. The actuator 12 is combined with the object lens 10, and drives the object lens 10 to adjust positions.

Arrangement sections, where the light emitting element 2, the polarized light beam splitter 3, the diffracting element 6, the light receiving element 7, and the actuator 12 are to be rigidly mounted, are formed in advance on the housing 1 (not illustrated). All optical components, such as the light emitting element 2, the polarized light beam splitter 3 (light guiding means), the diffracting element 6 (diffracting means), the light receiving element 7, and the actuator 12, that need to undergo adjustments, such as optical axis adjustment, positional adjustment, and posture adjustment, are mounted on the arrangement sections. This, as described later, avoids duplication of adjustments and simplifies the adjustments.

Note that it is preferable that the housing 1 be formed thick and made of molded resin such as PPS resin or a die-cast metal of aluminum, zinc, magnesium, or the like. This improves the strength of the optical pickup apparatus 40 and evenness in precision of processing the surfaces so that the positions of the optical components after the adjustments become stable. Thus, highly precise adjustment becomes possible.

As shown in FIGS. 1 and 2, an overlap section where the housing 1 and the light emitting element 2 overlap is in the shape of a recess. This allows the light emitting element 2 to be rigidly mounted on the housing 1 more stably.

In the overlap section where the housing 1 and the diffracting element 6 overlap, a through hole 18 is formed. It is preferable in the optical pickup apparatus 40 of the present invention that the overlap section where the housing and the diffracting element overlap be a through hole or in the shape of a recess. This is because an area in which the diffracting element is movable during positional adjustment is widened. It is even more preferable that the overlap section be a through hole. A jig for adjusting the position of the diffracting element is inserted from the top and the bottom of the through hole to adjust the position of the diffracting element from the top and the bottom.

Further, in an overlap section where the housing 1 and the light receiving element 7 overlap, a through hole 16 is formed. It is preferable in the optical pickup apparatus 40 of the present invention that the overlap section where the housing and the light receiving element overlap be a recess or a through hole. This is because an area in which the light receiving element is movable during positional adjustment is widened. Further, it is more preferable that the overlap section be a through hole. A jig for adjusting the position of the light receiving element is inserted from the top and the bottom of the through hole to adjust the position of the light receiving element from the top and the bottom. Further, a wiring for signal output, which wiring is connected to the light receiving element 7, is passed through the through hole 16 (not illustrated). This makes it unnecessary to keep a space on the housing 1 for the wiring so that it becomes possible to design a variety of layouts and reduce the size and the weight of the optical pickup apparatus 40. Further, a flexible substrate may be used as a base material to support a wiring for the signal output.

As shown in FIGS. 1 and 2, the light emitting element 2 including a semiconductor laser 13 and a holder 14, which supports the semiconductor laser 13, and the holder 14 is rigidly mounted on the housing 1, whereby the light emitting element 2 is rigidly mounted on the housing 1. It is preferable, in the same manner as in the housing 1 of the present embodiment, that the overlap section between the housing and the light emitting element be in the shape of a recess so that the light emitting element is rigidly mounted more stably.

The polarized light beam splitter 3 is rigidly mounted on the housing 1. The polarized light beam splitter 3 has a polarized light beam splitter surface 5 on an optical axis of a light beam emitted from the semiconductor laser 13. The polarized light beam splitter 3 also has a reflecting surface 4 provided parallel to the polarized light beam splitter surface 5. The polarized light beam splitter surface 5 has characteristics of transmitting linearly polarized light (P polarized light) having a plane-of-vibration in direction X, and reflecting linearly polarized light (S polarized light) having the plane-of-vibration in direction Y.

The diffracting element 6 is rigidly mounted on the polarized light beam splitter 3 in such a manner that the diffracting element 6 is positioned on the optical axis of the light beam emitted from the semiconductor laser 13, and faces the polarized light beam splitter surface 5.

The light receiving element 7 is rigidly mounted on the polarized light beam splitter 3 in such a manner that the light receiving element 7 is positioned to face the reflecting surface 4.

As the foregoing describes, the diffracting element 6 and the light receiving element 7 are rigidly mounted directly on the polarized light beam splitter 3 so that the polarized light beam splitter 3, the diffracting element 6, and the light receiving element 7 are integrated. Further, as shown in FIGS. 1 and 2, the light emitting element 2 is provided in the vicinity of the polarized light beam splitter 3 so that the semiconductor laser 13, the polarized light beam splitter 3, the diffracting element 6, and the light receiving element 7 are integrated at a section in the housing 1 to form the integrated optical unit 17.

In other words, the integrated optical unit is formed on the housing 1 without using a package component, while conventional integrated optical units utilize package components. That is to say, the integrated optical unit is formed by a discrete method. The discrete method here implies that an optical system is constituted solely of a semiconductor laser, without a hologram laser (integrated laser for optical pickups) including a semiconductor laser, a hologram element, a light receiving element, or the like in a package. Specifically, in the optical pickup apparatus 40 of the present invention, the semiconductor laser is used alone, and the optical components are integrated on the housing, whereby the integrated optical unit is formed. This is found for the first time by the inventors who have been worked diligently and have brought original ideas.

It is preferable that the light source, the light guiding means, the diffracting means, and the light receiving element are positioned as closely as possible. The positional relationships of those components are not particularly limited, as long as outer edges of the components do not overlap. In other words, integration of the optical components by the discrete method implies that the light source, the light guiding means, the diffracting means, and the light receiving element are mounted on the housing individually, without being integrated by use of a package component before mounted on the housing, and the optical components are positioned in such a manner that the outer edges of the optical components do not interfere (do not overlap).

If the integrated optical unit is produced by the discrete method, the optical pickup apparatus 40 is reduced in size and weight, and the process of adjustment is simplified. Thus, high-quality optical pickup apparatuses 40 are produced.

In the present embodiment, an exemplary case is discussed in which a polarization grating employed as the diffracting element 6 diffracts polarized light having a predetermined plane-of-vibration, and transmits, without processing, polarized light having a plane-of-vibration orthogonal to the predetermined plane-of-vibration. Specifically, the diffracting element 6 of the present embodiment is a polarization grating that transmits, without processing, linearly polarized light (P polarized light) having a plane-of-vibration in direction X, and diffracts linearly polarized light (S polarized light) having a plane-of-vibration orthogonal to the plane-of-vibration of the P polarized light. Use of the polarization grating makes it possible to minimize the loss of light in amount at the time when a light beam emitted from the semiconductor laser 13 passes through the diffracting element 6 and the loss of light in amount at the time when return light having been reflected from the optical disk passes through the diffracting element 6. Thus, the use of light is efficient.

Further, the diffracting element 6 may be a non-polarization grating. The non-polarization grating is inexpensive. With the non-polarization grating, the loss of light in amount is not reduced as much as in the case in which a polarization grating is employed, but efficiency in the use of light is ensured if the semiconductor laser is arranged in advance so as to produce high output. Either of the polarization grating and the non-polarization grating may be selected in a manner that depends on costs or output of the semiconductor laser that is employed.

Further, in the present embodiment, the diffracting element 6 has a hologram section to divide the return light into non-diffracted light and diffracted light. This makes it possible to generate a signal indicating a deviation of a spot where a tracking error signal or the like is received, on the basis of the non-diffracted light and the diffracted light.

The following describes operation of the optical pickup apparatus 40 of the present embodiment.

A light beam 15 emitted from the semiconductor laser 13 is linearly polarized light (P polarized light) having the plane-of-vibration in direction X with respect to the optical-axis direction (direction Z) shown in the figures. Therefore, the light beam 15 (P polarized light) having entered the polarized light beam splitter surface 5 passes through the polarized light beam splitter surface 5 and then enters the diffracting element 6.

The light beam 15 (P polarized light) having entered the diffracting element 6 passes through the diffracting element 6, enters the collimator lens 8 to become parallel light, and then enters the quarter-wave plate 9.

The light beam 15 (P polarized light) having entered the quarter-wave plate 9 is converted from a light beam of linearly polarized light into a light beam of circularly polarized light, reflected by the rising mirror 11, passes through the object lens 10, and then gathered onto an optical recording medium (not illustrated).

The light beam (return light) (not illustrated) having been reflected from the optical recording medium passes through the object lens 10 again, and then enters the quarter-wave plate 9. At this time, the light beam (return light) is converted from circularly polarized light into linearly polarized light to become linearly polarized light (S polarized light) having the plane-of-vibration in direction Y.

This return light (S polarized light) passes through the collimator lens 8, and then enters the diffracting element 6. The return light having entered the diffracting element 6 is diffracted into 0th order diffracted light (non-diffracted light) and ±first order diffracted light (diffracted light) by a hologram section of the diffracting element 6.

The return light (S polarized light) having been diffracted by the diffracting element 6 enters the polarized light beam splitter 3, is reflected by the polarized light beam splitter surface 5, is reflected by the reflecting surface 4, and then is received by the light receiving element 7.

The following describes a method of producing the optical pickup apparatus 40 in accordance with the present invention, with reference to FIGS. 1 to 3.

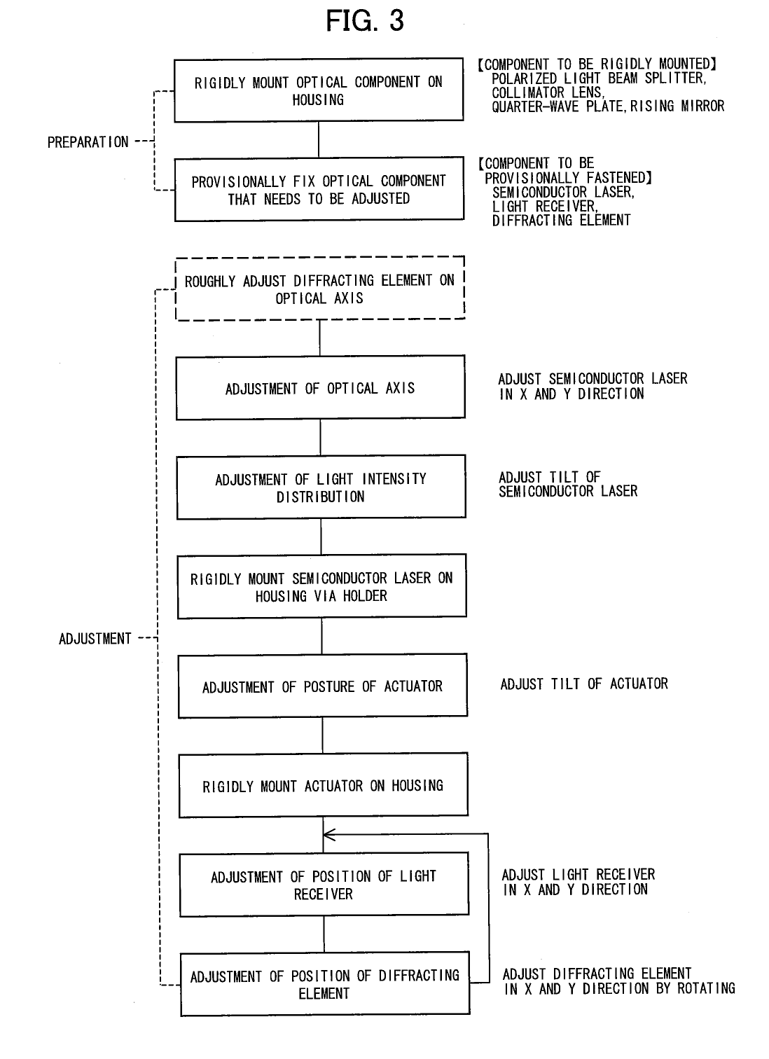

FIG. 3 is a flowchart showing a process of the method of producing the optical pickup apparatus 40 in accordance with the present invention. The method includes preparation (preparation to form an integrated optical unit) and adjustment, as shown in FIG. 3.

In the preparation, optical components, such as the polarized light beam splitter 3, the collimator lens 8, the quarter-wave plate 9, and the rising mirror 11, are rigidly mounted on the housing 1, as shown in FIG. 3.

Then, optical adjustment components on which positional adjustment or the like needs to be carried out later are rigidly mounted (provisionally fastened) on the housing 1. Specifically, the holder 14 to support the semiconductor laser 13 is rigidly mounted (provisionally fastened) on the housing 1, and the diffracting element 6 and the light receiving element 7 are rigidly mounted (provisionally fastened) on the polarized light beam splitter 3 fixed to the housing 1.

Furthers the actuator 12 is brought into contact with the housing 1 to be rigidly mounted (provisionally fastened) on the housing 1 (settling the object lens). The actuator 12 includes the object lens 10 for gathering, to the optical recording medium, a light beam emitted from the semiconductor laser 13, and activates the object lens 10.

In the present Specification, the language “provisionally fastened” implies that a component is rigidly mounted in a movable manner so that the position of the component is adjustable. Concretely, the component may be rigidly mounted by use of a leaf spring or the like.

It is preferable that, prior to optical-axis adjustment described below, the diffracting element 6 be roughly adjusted in advance so as to be positioned on the optical axis, and then be provisionally fastened.

The actuator 12 is mounted on the housing 1 before the posture of the actuator 12 is adjusted as described below. Further, the wiring for signal output, which wiring is connected to the light receiving element 7 as described above, may be passed through the through hole 16 in this process of preparation or after the position of the light receiving element 7 is determined as described below (inserting the wiring).

With the optical pickup apparatus 40 thus obtained, the process of adjustment, which will be described below and is carried out to optimize the MPP balance and the like, is simplified. Components to keep the outputs of the semiconductor laser, such as a front monitor and a focusing lens, constant are mounted on the housing during the process of producing the optical pickup apparatus 40.

The following describes the process of adjustment.

First, the optical axis of the light beam to be emitted from the semiconductor laser 13 is adjusted, and the light intensity distribution is adjusted so as to match the optical axis. The diffracting element 6 is roughly adjusted in advance so as to be positioned on the optical axis of the light beam.

The optical axis and the light intensity distribution are adjusted by adjusting the semiconductor laser 13 in directions X and Y, and adjusting the angle at which the semiconductor laser 13 is positioned (adjust a tilt).

Once adjustment of the optical axis and the light intensity distribution are completed, the position of the holder 14 with respect to the housing 1 is settled. In other words, the position of the light emitting element 2 with respect to the housing 1 is settled at this time.

Thereafter, the posture of the actuator 12 is adjusted. The object lens 10 mounted on the actuator 12 is placed at a position (reference position) to optimize the MPP balance that is calculated in advance. Slight correction (approximately several tens of microns) of the position may become necessary due to assembly deviation of the actuator, but the object lens 10 does not need to be moved far from the reference position.

The main purpose of this adjustment of the posture of the actuator 12 is to place the object lens at an optimum position by tilting the actuator 12 to adjust the posture of the actuator 12 so that coma aberration is reduced to a minimum. Once the object lens 10 is adjusted to the optimum position, the position of the actuator 12 with respect to the housing 1 is settled (settling the object lens). Then, optical adjustment from the semiconductor laser 13 to the optical recording medium (adjustment to a going optical system) is completed.

Then, the positions of the diffracting element 6 and the light receiving element 7 are adjusted to adjust from the light beam (return light) reflected from the optical recording medium is received by the light receiving element 7 (adjustment to a returning optical system).

First, with the diffracting element 6 being roughly adjusted on the optical axis of the light beam, the light receiving element 7 divides the light receiving section for 0th order diffracted light into four. The light receiving element 7 then outputs 0th order diffracted light that is received, monitors the light, and then carries out positional adjustment in directions X and Y and positional adjustment by rotation around a straight line parallel to direction Z so that respective outputs are equalized.

The position of the diffracting element 6 is adjusted in the following manner. Diffracted light received by the light receiving section for the ± first order diffracted light is output and then monitored, and positional adjustment is carried out in directions X and Y so that respective outputs are equalized. Thereafter, positional adjustment is carried out by rotation around a straight line parallel to direction Z while checking jitter (temporal deviation in signals for recording or reproducing information with the optical recording medium) to eliminate deviation in a focal point.

If the outputs of the light receiving section of the light receiving element 7 for the 0th order diffracted light are equal after the position of the diffracting element 6 is adjusted, then the position of the diffracting element 6 is settled. At the end, the position of the light receiving element 7 is settled. If the outputs of the light receiving section of the light receiving element 7 for the 0th order diffracted light are not equal, then fine adjustment of the positions of the diffracting element 6 and the light receiving element 7 is carried out again.

This is repeated until the outputs of the light receiving section of the diffracting element 6 for the first order diffracted light and the outputs of the light receiving section of the light receiving element 7 for the 0th order diffracted light are equalized. Then, the adjustment process is completed.

Accordingly, with the method of producing the optical pickup apparatus 40 in accordance with the present invention, it becomes unnecessary to carry out adjustment as the way it has been carried out conventionally, that is to say, an integrated optical unit is assembled and adjusted, and during the process of assembling the optical pickup apparatus 40, the integrated optical unit is adjusted again. In other words, all of the optical components that need to be adjusted are mounted on the housing 1 so that all adjustments need to be carried out only once on the housing 1. This simplifies the process of adjustment.

### Embodiment 2

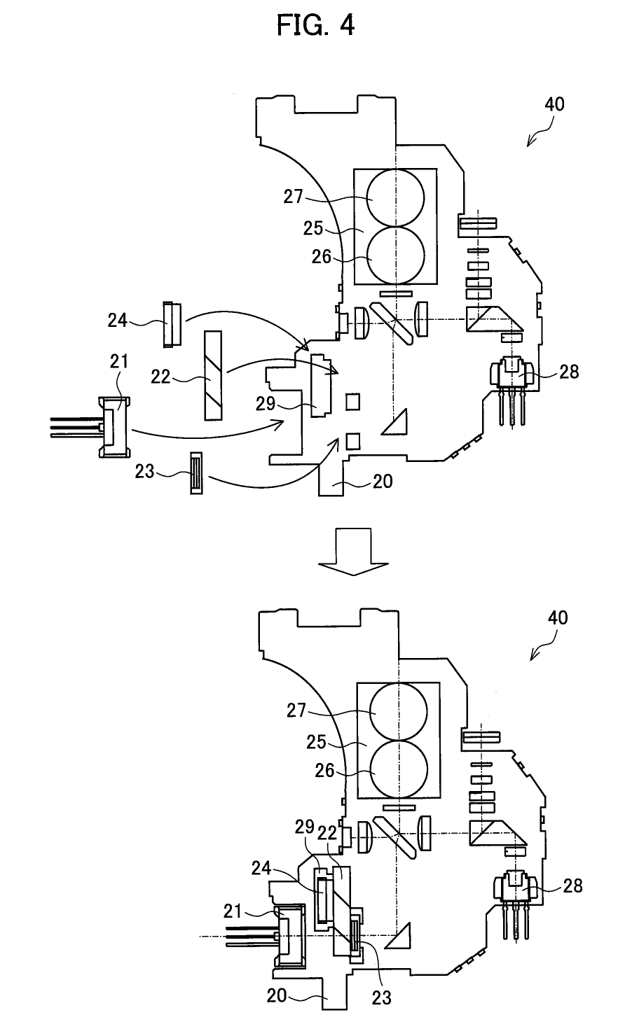

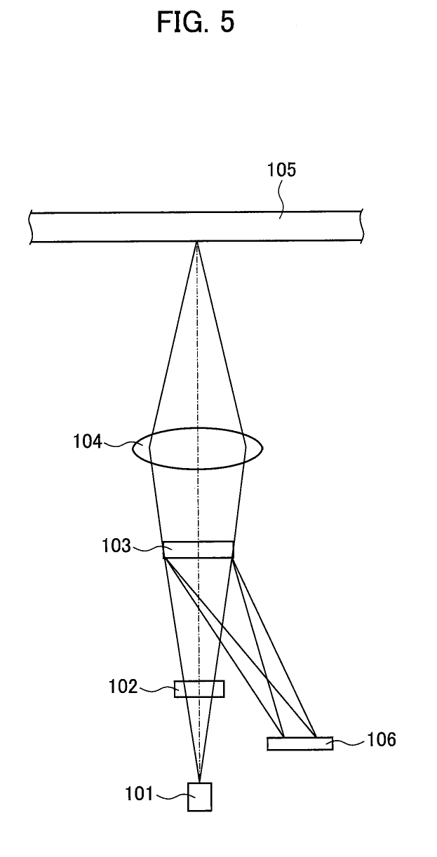

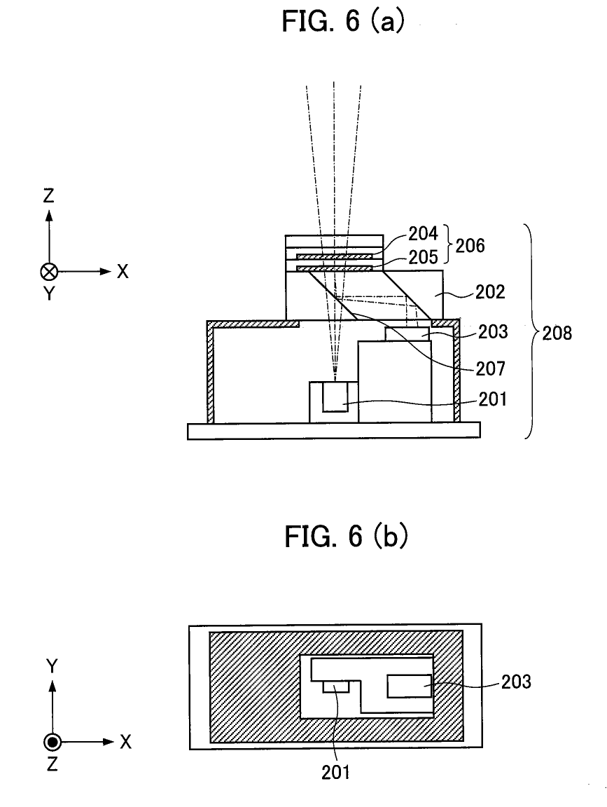

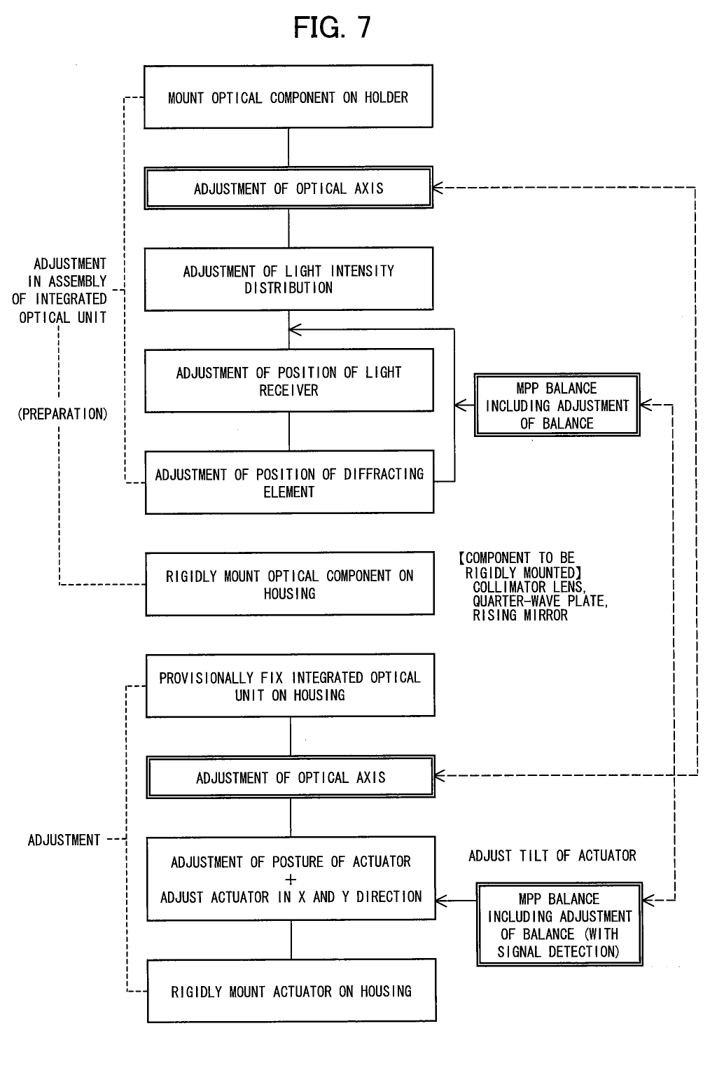

With a method of producing an optical pickup apparatus 40 in accordance with the present invention, the optical pickup apparatuses 40 including light source of plural wavelengths are produced with simplified positional adjustment and the like. In the present embodiment, an embodiment in which an optical pickup apparatus 40 including a plurality of light sources of different wavelengths is produced by the method of producing the optical pickup apparatus 40 in accordance with the present invention is described, with reference to FIG. 4. Only the differences from Embodiment 1 are described in the present embodiment.

FIG. 4 schematically shows how the optical pickup apparatus 40 for three wavelengths (red laser, infrared laser, blue laser) is produced by the method of producing the optical pickup apparatus 40 in accordance with the present invention.

As shown in FIG. 4, the optical pickup apparatus 40 of the present embodiment includes a semiconductor laser (blue optical system) 21, which emits a blue laser beam; an object lens (blue optical system) 26, which corresponds to the semiconductor laser (blue optical system) 21; a semiconductor laser (red optical system, infrared optical system) 28 for two wavelengths, which semiconductor laser 28 emits a red laser beam and an infrared laser beam; and an object lens (red optical system, infrared optical system) 27, which corresponds to the semiconductor laser (red optical system, infrared optical system) 28. The object lens (blue optical system) 26 and the object lens (red optical system, infrared optical system) 27 are driven by the actuator 25. Adjustment of the position of the actuator 25 significantly affects characteristics in recording or reproducing information with an optical recording medium by the respective optical systems.

In the optical pickup apparatus 40 of the present embodiment, a semiconductor laser (blue optical system) 21, a semiconductor laser (red optical system, infrared optical system) 28, a polarized light beam splitter (light guiding means) 22, a diffracting element (diffracting means) 23, a light receiving element 24, and an actuator 25 are rigidly mounted on the housing 20 having a through hole 29 to widen an area where the light receiving element 24 is movable during positional adjustment, as shown in FIG. 4.

As the foregoing describes, all of the optical components that need to be adjusted are mounted on the housing 20 so that it becomes possible to carry out all of the adjustment processes on the housing 20. Thus, the adjustment processes are simplified, and assembly deviations are reduced.

The following concretely describes the adjustment process of the optical pickup apparatus 40 of the present embodiment.

First, the position of the object lens (blue optical system) 26 is adjusted by the actuator 25 using, as a reference, the blue optical system of a short wavelength that requires highly precise adjustment. In this case, the object lens (blue optical system) 26 is positioned approximately at the reference position of the actuator 25.

Even after the actuator 25 adjusts the position of the object lens (red optical system, infrared optical system) 27 thereafter by using the red optical system and the infrared optical system as references, the position of the object lens (red optical system, infrared optical system) 27 is fixed approximately at the reference position. This makes it easy to adjust the light receiving section. Thus, a high-quality optical pickup apparatus 40 is obtained.

As the foregoing describes, with the optical pickup apparatus 40 of the present invention, a high-quality optical pickup apparatus 40 including a plurality of light sources having different wavelengths from those three wavelengths is produced with simplified adjustment of the positions of the optical components.

Further, for example in an optical pickup apparatus 40 for three wavelengths, that is slim and is to be mounted on laptop personal computers, a projected area of a light beam on the optical recording medium is very small. Thus, the sizes of the optical systems need to be reduced to as small as possible, and the weights of the optical systems need to be reduced as light as possible. This requires highly precise adjustment is required as the sizes and weights are reduced. With the method of producing the optical pickup apparatus 40 in accordance with the present invention, the optical pickup apparatus 40 is reduced in size and weight, and yet highly precise adjustment is possible, as described above. The method of the present invention is thus suitably applicable to production of such slim optical pickup apparatuses 40 for three wavelengths.

### Comparative Example

The following describes, as a Comparative Example to Embodiment 2 discussed above, a method of adjusting a position of an actuator of an optical pickup apparatus 41 for three wavelengths (red laser, infrared laser, blue laser), which optical pickup apparatus 41 is produced by a method (conventional method) in which an integrated optical unit is assembled first and then mounted.

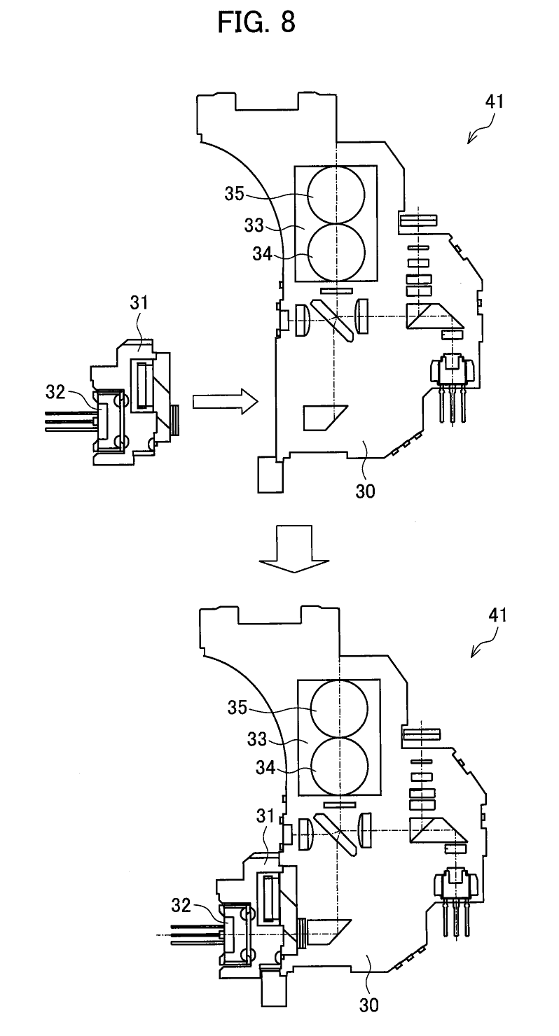

FIG. 8 is a figure schematically showing how the optical pickup apparatus 41 for three wavelengths (red laser, infrared laser, blue laser) is produced by the conventional method.

In the optical pickup apparatus 41 of the present Comparative Example, an integrated optical unit 31 including a semiconductor laser (blue optical system) 32 and the like is mounted on a housing 30 including an actuator 33 supporting an object lens (blue optical system) 34 and an object lens (red optical system, infrared optical system) 35.

Using, as a reference, the blue optical system of the semiconductor laser (blue optical system) 32, which emits a blue laser having a short wavelength requiring highly precise adjustment, the actuator 33 adjusts the positions of the object lenses (the object lens (blue optical system) 34 and the object lens (red optical system, infrared optical system) 35).

At this time, adjustment of the integrated optical unit 31 including the semiconductor laser (blue optical system) 32 is already completed in a different adjustment process. However, the optical system used as the reference in the process of adjusting the integrated optical unit 31 and the optical system at the time when the integrated optical unit 31 is mounted on the housing 30 do not always match due to assembly deviation in the optical components that are mounted on the housing 30 and are other than those constituting the integrated optical unit 31.

Thus, to optimize the MPP balance, the position of the object lens (blue optical system) 34 deviates from the reference position also when the actuator 33 adjusts the position of the object lens (blue optical system) 34. If the object lens (blue optical system) 34 is to be fixed at the reference position, deterioration in quality is not avoidable. Thus, the position of the object lens (blue optical system) 34 is adjusted using the blue optical system as a reference and then is fixed, and thereafter the position of the object lens (red optical system, infrared optical system) 35 is adjusted using the red optical system and the infrared optical system as references. If this adjustment of the positions is carried out, the object lens (red optical system, infrared optical system) 35 deviates from the reference position because the actuator 33 is fixed. Consequently, the positions of the light receiving elements of the red optical system and the infrared optical system and the like need to be adjusted using the object lens (red optical system, infrared optical system) 35, which deviates from the reference position, as a reference, causing deterioration in quality of the optical pickup apparatus 41. This gives a significant impact especially on the quality of a spot at the time of recording information with the optical recording medium.

The present invention is not limited to the description of the embodiments above, but may be altered by a skilled person within the scope of the claims. An embodiment based on a proper combination of technical means disclosed in different embodiments is encompassed in the technical scope of the present invention.

As the foregoing describes, in the optical pickup apparatus in accordance with the present invention, an integrated optical unit including at least a light emitting element, a light receiving element, and an optical element is mounted on a housing. Arrangement sections for those devices to be rigidly mounted are formed on the housing. The devices are rigidly mounted on the arrangement sections so that the integrated optical unit is installed integrally on the housing.

The integrated optical unit including at least the light emitting element, the light receiving element, and the optical element is mounted directly on the housing. This makes it possible to adjust the positions of the light emitting element, the light receiving element, and the optical element on one housing. Thus, the optical pickup apparatus is produced with simplified adjustment. In other words, it is not necessary to carry out adjustment twice as the way it has been carried out conventionally, that is to say, adjustment is carried out in the integrated optical element, and then adjustment is carried out again after the integrated optical unit is installed on the housing. This makes it possible to produce the optical pickup apparatus through a reduced number of processes. Further, conventionally, there has been a deviation between a reference optical system, which is referred to when the optical components are adjusted in the integrated optical unit, and an optical system at the time when the integrated optical unit is actually installed on the housing. This complicates the adjustments, and deviations easily occur. However, with the above structure, this problem does not occur since all adjustments are carried out on one housing.

Further, to ensure strength, the housing is normally made thick using a die-cast metal of aluminum, zinc, magnesium, or the like, or a molded resin such as PPS resin. This improves evenness in precision of processing the surfaces. Further, the optical components are mounted directly onto the die-cast metal and the molded resin. Thus, it becomes possible to produce the optical pickup apparatuses with simplified adjustment including positional adjustment. Further, the optical components are rigidly mounted directly onto the housing, without requiring a package component of low strength, such as a conventional integrated optical unit. Thus, the optical components do not move during the adjustments so that the positions of the optical components after the adjustment are stabilized.

Further, the light emitting element, the light receiving element, and the optical element are integrated into a unit so that the size and the weight of the optical pickup apparatus are reduced.

This produces an advantage that a small, light, and high quality optical pickup apparatus is provided.

The optical pickup apparatus produced by the method in accordance with the present invention is applicable to optical information recorder-reproducers for recording and reproducing information with an optical recording medium, such as optical disks of a CD group, a DVD group, and a BD group.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

It is preferable that the optical pickup apparatus in accordance with the present invention further include: light source means, serving as the light emitting element, for emitting a light beam; an object lens, serving as the optical element, for gathering, to an optical recording medium, the light beam having been emitted from the light source means; light guiding means for guiding, in a direction different from a direction of the light source means, return light which is the light beam having been reflected from the optical recording medium; and diffracting means for diffracting the light beam and the return light.

With this structure, the light source means is rigidly mounted directly on the housing to be integrated with the optical components such as the diffracting element. This makes it possible to adjust the optical axis and the light intensity distribution of the light source, in addition to the adjustment of the positions of the rest of the optical elements other than the light receiving element and the light source means, on one housing. It thus becomes unnecessary to carry out adjustment as the way it has been carried out conventionally, that is to say, the optical axis and the like is adjusted at the time when the components of the integrated optical unit are assembled, and then the optical axis is adjusted again on the housing. Further, the light guiding means is included for guiding return light to a direction different from the direction of the light source means. Thus, the degree of freedom in design of the optical components increases. This allows the optical pickup apparatuses to be reduced further in size and weight. Further, the diffracting means is included so that signals for detecting errors become obtainable on the basis of diffracted light.

It is further preferable that the optical pickup apparatus in accordance with the present invention include object lens adjusting means for adjusting a position of the object lens, the object lens adjusting means being combined with the object lens and rigidly mounted on the housing.

With this structure, the position of the object lens is adjusted by the object lens adjusting means so that the precision of recording and reproduction with the optical recording media improves. Further, the object lens adjusting means is integrated and rigidly mounted on the housing. This makes it possible to adjust the positions of the light emitting element, the light receiving element, and the optical element, and the posture of the object lens on one housing. Thus, the positional adjustment and the like are simplified and are carried out more precisely.

It is preferable in the optical pickup apparatus in accordance with the present invention that the light guiding means has a function surface that transmits the light beam and reflects the return light which is the light beam having been reflected from the optical recording medium.

With this structure, the degree of freedom in the layout of the light receiving element, which receives return light, increases. Thus, it becomes possible to further reduce the size and the weight of the optical pickup apparatus.

It is preferable in the optical pickup apparatus in accordance with the present invention that the light guiding means includes a reflecting surface that reflects the return light having been reflected from the function surface.

The reflecting surface is included so that the degree of freedom in layout of the light receiving element increases. This produces an advantage that the optical pickup apparatuses are allowed to be reduced further in size and weight.

It is further preferable in the optical pickup apparatus in accordance with the present invention that the diffracting means is a polarization grating that diffracts polarized light having a predetermined plane-of-vibration and transmits, without changing, polarized light having a plane-of-vibration that is orthogonal to the predetermined plane-of-vibration.

Employment of the polarization grating makes it possible to reduce, to a minimum, the loss of light in amount at the time when a light beam passes through the diffracting element and at the time when return light having been reflected from the optical disk passes through the diffracting element. This produces a further advantage that efficiency in the use of light improves.

It is preferable in the optical pickup apparatus in accordance with the present invention that the diffracting means be a non-polarization grating.

The non-polarization grating is inexpensive. Thus, a further advantage is produced that optical pickup apparatuses are provided at low costs.

It is preferable in the optical pickup apparatus in accordance with the present invention that the diffracting means have a hologram section to divide the return light into non-diffracted light and diffracted light.

On the basis of the non-diffracted light and the diffracted light, signals to indicate deviations of spots where light, such as tracking error signals, is received are generable. With the signals, the position of the object lens or the like is adjustable. This produces a further advantage that optical pickup apparatuses of higher quality are provided.

It is preferable in the optical pickup apparatus in accordance with the present invention that the diffracting means be provided on an optical axis of the light beam emitted from the light source means.

The diffracting means is provided on the optical axis so that most part of paths of an optical system of a light beam emitted from the light source and an optical system of a light beam of return light of the light beam having been reflected from the optical recording medium are brought close. This produces a further advantage that small and light optical pickup apparatuses are provided.

It is preferable in the optical pickup apparatus in accordance with the present invention that the diffracting means be in contact with the light guiding means.

The diffracting means and the light guiding means are rigidly mounted directly so that, compared with a case in which the diffracting means and the light guiding means are mounted individually on a housing, assembly deviation is reduced. Further, the diffracting means and the light guiding means are integrated. This produces a further advantage that optical pickup apparatuses improved in precision and reduced in size and weight are provided.

It is preferable in the optical pickup apparatus in accordance with the present invention that the light guiding means be in contact with the light receiving element.

The light receiving element and the light guiding means are rigidly mounted directly so that, compared with a case in which the light receiving element and the light guiding means are mounted individually on a housing, assembly deviation is reduced. Further, the light receiving element and the light guiding means are integrated. This produces an advantage that optical pickup apparatuses improved in precision and reduced in size and weight are provided.

It is preferable in the optical pickup apparatus in accordance with the present invention that an overlap section of the housing, in which overlap section the housing and the light emitting element overlap, be in a shape of a recess.

This allows the light emitting element to be fixed more stably so that the light emitting element does not move. Thus, highly precise optical pickup apparatuses are provided.

It is preferable in the optical pickup apparatus in accordance with the present invention that an overlap section of the housing, in which overlap section the housing and the diffracting means overlap, be a through hole or in a shape of a recess.

The overlap section is either in the shape of a recess or a through hole so that, when the position of the diffracting means is adjusted, the diffracting means is movable in a wider area. This produces a further advantage that optical pickup apparatuses having undergone highly precise positional adjustment are provided.

It is preferable in the optical pickup apparatus of the present invention that an overlap section of the housing, in which overlap section the housing and the light receiving element overlap, be a through hole or in a shape of a recess.

The overlap section is either in the shape of a recess or a through hole so that, when the position of the light receiving element is adjusted, the light receiving element is movable in a wider area. This produces a further advantage that optical pickup apparatuses having undergone highly precise positional adjustment are provided.

It is preferable in the optical pickup apparatus of the present invention that the overlap section be a through hole.

A jig for adjusting the position of the light receiving element is inserted, from the top and the bottom, into the through hole so that the position of the light receiving element is adjusted from the top and the bottom. Thus, highly precise optical pickup apparatuses are provided.

It is preferable in the optical pickup apparatus of the present invention that a wiring, connected to the light receiving element, for outputting a signal be passed through the through hole

The wiring for outputting a signal, which wiring is connected to the light receiving element, is passed through the through hole so that it becomes unnecessary to have a space for the wiring on the housing, allowing a variety of layouts to be designed. This produces a further advantage that the optical pickup apparatuses are reduced in size and weight.

It is further preferable in the optical pickup apparatus of the present invention that a plurality of light sources be used as the light source means to produce light beams of different wavelengths, and a plurality of object lenses corresponding to the plurality of light sources be used.

The plurality of light sources are used so that information are recorded and reproduced with the optical recording media by use of light beams of plural wavelengths. This produces a further advantage that optical pickup apparatuses of higher quality are provided.

It is preferable in a housing of an optical pickup apparatus of the present invention that, when the light emitting element is provided, an overlap section in which the housing and the light emitting element overlap be a recess.

This allows the light emitting element to be fixed more stably so that the light emitting element does not move. Thus, highly precise optical pickup apparatuses are provided.

It is preferable in the housing of the optical pickup apparatus of the present invention that, when the diffracting means is provided, an overlap section in which the housing and the diffracting means overlap be a recess or a through hole

The overlap section is either in the shape of a recess or a through hole so that, when the position of the diffracting means is adjusted, the diffracting means is movable in a wider area. This produces a further advantage that optical pickup apparatuses having undergone highly precise positional adjustment are provided.

It is preferable in the housing of the optical pickup apparatus of the present invention that, when the light receiving element is provided, an overlap section in which the housing and the light receiving element overlap be a recess or a through hole

The overlap section is either in the shape of a recess or a through hole so that, when the position of the light receiving element is adjusted, the light receiving element is movable in a wider area. This produces a further advantage that optical pickup apparatuses having undergone highly precise positional adjustment are provided.

It is preferable in a method of producing an optical pickup apparatus in accordance with the present invention that at least a position of the light receiving element be adjusted in the adjusting.

With this arrangement, the MPP balance is optimized by adjusting the position of the light receiving element. This produces a further advantage that high-quality optical pickup apparatuses are provided.

It is preferable in the method of producing the optical pickup apparatus in accordance with the present invention that, if: light source means for emitting a light beam is used as the light emitting element; an object lens gathering, to an optical recording medium, the light beam having been emitted from the light source means is used as the optical element; light guiding means for guiding, in a direction different from a direction of the light source means, return light which is the light beam having been reflected from the optical recording medium is used as the optical element; and diffracting means for diffracting the light beam and the return light is used as the optical element, then the optical adjustment includes at least one of adjusting a position of the diffracting means and adjusting an optical axis and a light intensity distribution of the light source means.

With this arrangement, the light beam is gathered onto the optical recording medium by the object lens to record and reproduce information so that precision of recording and reproducing information with the optical recording medium improves. Further, the light guiding means for guiding the return light to the direction different from that of the light source means. Thus, the degree of freedom in design of the optical components improves. Therefore, the optical pickup apparatuses are reduced further in size and weight. Further, the diffracting means is included so that signals for detecting errors are obtainable on the basis of the diffracted light. Further, the light source means is rigidly mounted directly on the housing so as to be integrated with the optical components such as the diffracting element. Thus, the adjustment of the optical axis of the light source and the adjustment of the light intensity distribution are carried out on one housing, along with the adjustment of the positions of the light receiving element and the optical element. Therefore, it is not necessary to carry out adjustment as the way it has been carried out conventionally, that is to say, the optical axis is adjusted when the components of the integrated optical unit are assembled, and then the adjustment of the optical axis is carried out again on the housing.

Further, the MPP balance is optimized by adjusting the optical axis, the light intensity distribution, and the position of the diffracting means.

This produces an advantage that high-quality optical pickup apparatuses are provided.

It is further preferable that the method of producing the optical pickup apparatus in accordance with the present invention further include, if the overlap section of the housing, in which overlap section the housing and the light receiving element overlap, is a through hole, a wiring passing step of passing a wiring, for outputting a signal, through the through hole, the wiring being connected to the light receiving element.

With this arrangement, the overlap section is either in the shape of a recess or a through hole so that, when the position of the light receiving element is adjusted, the light receiving element is movable in a wider area. This makes it possible to adjust the position highly precisely. Further, the jig for adjusting the position of the light receiving element is inserted into the through hole from the top and the bottom, in order to adjust the position of the light receiving element from the top and the bottom. Further, the wiring, connected to the light receiving element, is passed through the through hole. This makes it unnecessary to keep a space on the housing for the wiring so that it becomes possible to design a variety of layouts. Thus, a further advantage is produced that a small, light, and high-quality optical pickup apparatus is provided.

It is further preferable that the method of producing the optical pickup apparatus in accordance with the present invention include rigidly mounting the object lens and the object lens adjusting means to the housing, if the object lens adjusting means for adjusting the position of the object lens is used in combination with the object lens.

With this arrangement, the position of the object lens is adjustable by the object lens adjusting means. Thus, precision of recording and reproducing information with the optical recording medium improves. Further, the object lens adjusting means is integrated and rigidly mounted on the housing. This makes it possible to carry out the adjustment of the posture of the object lens and the adjustment of the positions and the like of the light emitting element, the light receiving element, and the optical element on one housing. Thus, the positional adjustments and the like are further simplified and, at the same time, carried out highly precisely.

It is further preferable in the method of producing the optical pickup apparatus in accordance with the present invention that, in the preparation step, the diffracting means be rigidly mounted on an optical axis of the light beam emitted from the light source means.

With this arrangement, the diffracting means is provided on the optical axis. most part of paths of an optical system of a light beam emitted from the light source and an optical system of a light beam of return light of the light beam having been reflected from the optical recording medium are brought close. This produces an advantage that the size and the weight of the optical pickup apparatus are reduced.

It is further preferable in the method of producing the optical pickup apparatus in accordance with the present invention that, in the preparation step, the diffracting means or the light receiving element is rigidly mounted on the light guiding means rigidly mounted on the housing.

With this arrangement, (i) the diffracting means or the light receiving element and (ii) the light guiding means are rigidly mounted directly so that, with the case in which the diffracting means, the light receiving element, and the light guiding means are mounted individually on the housing, assembly deviation is reduced. Further, the diffracting means is integrated with the light guiding means. This produces a further advantage that optical pickup apparatuses that are highly precise, small, and light are provided.

It is further preferable in the method of producing the optical pickup apparatus in accordance with the present invention that, in the preparation step, the light emitting element is rigidly mounted on the light guiding means rigidly mounted on the housing, or in a vicinity of the arrangement section of the housing for the light guiding means

The light emitting element and the light guiding means are further integrated and provided. This produces a further advantage that the size and the weight of the optical pickup apparatus are further reduced.

An optical pickup apparatus in accordance with the present invention is adapted so that the optical pickup apparatus include any one of the housings above.

With this structure, when the optical components, such as the light source, the diffracting element, the light guiding means, the light receiving element, and the actuator, are mounted, adjustment of the optical components is carried out through a simplified process. Thus, highly precise adjustment becomes possible, and high-quality optical pickup apparatuses are provided.

An optical information recorder-reproducer in accordance with the present invention is adapted so that the optical information recorder-reproducer include any one of the optical pickup apparatuses above.

With this structure, the optical pickup apparatus of the present invention is provided. This produces an advantage that high-quality optical information recorder-reproducers are provided.

What is claimed is:

1. An optical pickup apparatus in which an integrated optical unit is installed on a housing and includes at least a light emitting element, a light receiving element, and an optical element,
said housing including arrangement sections on which respective elements of said at least the light emitting element, the light receiving element, and the optical element are to be rigidly mounted so that said respective elements are integral with the housing via the arrangement sections.

2. The optical pickup apparatus of claim 1, further comprising:
light source means, serving as the light emitting element, for emitting a light beam;
an object lens, serving as the optical element, for gathering, to an optical recording medium, the light beam having been emitted from the light source means;
light guiding means for guiding, in a direction different from a direction of the light source means, return light which is the light beam having been reflected from the optical recording medium; and
diffracting means for diffracting the light beam and the return light.

3. The optical pickup apparatus of claim 2, further comprising object lens adjusting means for adjusting a position of the object lens,
the object lens adjusting means being combined with the object lens and rigidly mounted on the housing.

4. The optical pickup apparatus of claim 2, wherein the light guiding means has a function surface that transmits the light beam and reflects the return light which is the light beam having been reflected from the optical recording medium.

5. The optical pickup apparatus of claim 4, wherein the light guiding means includes a reflecting surface that reflects the return light having been reflected from the function surface.

6. The optical pickup apparatus of claim 2, wherein the diffracting means is a polarization grating that diffracts polarized light having a predetermined plane-of-vibration and transmits, without changing, polarized light having a plane-of-vibration that is orthogonal to the predetermined plane-of-vibration.

7. The optical pickup apparatus of claim 2, wherein the diffracting means is a non-polarization grating.

8. The optical pickup apparatus of claim 2, wherein the diffracting means has a hologram section to divide the return light into non-diffracted light and diffracted light.

9. The optical pickup apparatus of claim 2, wherein the diffracting means is provided on an optical axis of the light beam emitted from the light source means.

10. The optical pickup apparatus of claim 2, wherein the diffracting means is in contact with the light guiding means.

11. The optical pickup apparatus of claim 2, wherein the light guiding means is in contact with the light receiving element.

12. The optical pickup apparatus of claim 1, wherein an overlap section of the housing, in which overlap section the housing and the light emitting element overlap, is in a shape of a recess.

13. The optical pickup apparatus of claim 2, wherein an overlap section of the housing, in which overlap section the housing and the diffracting means overlap, is a through hole or in a shape of a recess.

14. The optical pickup apparatus of claim 1, wherein an overlap section of the housing, in which overlap section the housing and the light receiving element overlap, is a through hole or in a shape of a recess.

15. The optical pickup apparatus of claim 14, wherein:
the overlap section is a through hole; and
a wiring, connected to the light receiving element, for outputting a signal is passed through the through hole.

16. The optical pickup apparatus of claim 2, wherein:
a plurality of light sources are used as the light source means to produce light beams of different wavelengths; and
a plurality of object lenses corresponding to the plurality of light sources are used.

17. An optical pickup apparatus in which an integrated optical unit and object lens adjusting means for adjusting a position of an object lens gathering, to an optical recording medium, a light beam having been emitted from light source means are installed, which integrated optical unit includes at least the light source means for emitting the light beam, a light receiving element, light guiding means for guiding, in a direction different from a direction of the light source means, return light which is the light beam having been reflected from the optical recording medium, and diffracting means for diffracting the light beam and the return light,
the optical pickup apparatus comprising a housing having arrangement sections, formed in advance, on which the light source means, the light receiving element, the light guiding means, the diffracting means, and the object lens adjusting means are to be rigidly mounted.

18. A method of producing an optical pickup apparatus in which an integrated optical unit is installed on a housing and includes at least a light emitting element, a light receiving element, and an optical element,
said housing including arrangement sections on which respective elements of said at least the light emitting element, the light receiving element, and the optical element are to be rigidly mounted,
the method comprising:
preparing for forming the integrated optical unit integral with the housing by rigidly mounting the respective elements on the arrangement sections of the housing; and
making optical adjustment to the respective elements being rigidly mounted.

19. The method of claim 18, wherein if:
light source means for emitting a light beam is used as the light emitting element;
an object lens gathering, to an optical recording medium, the light beam having been emitted from the light source means is used as the optical element;
light guiding means for guiding, in a direction different from a direction of the light source means, return light which is the light beam having been reflected from the optical recording medium is used as the optical element; and
diffracting means for diffracting the light beam and the return light is used as the optical element,
then the optical adjustment includes at least one of adjusting a position of the diffracting means and adjusting an optical axis and a light intensity distribution of the light source means.

20. An optical information recorder-reproducer comprising the optical pickup apparatus defined in claim 1.
